(19) United States
(12) Patent Application Publication
(10) Pub. No.: US 2026/0010787 A1
(43) Pub. Date: Jan. 8, 2026

(54) Artificial Intelligence Long-term Memory System

(71) Applicant: Joseph Allan Lindahl, Belle Plaine, MN (US)

(72) Inventor: Joseph Allan Lindahl, Belle Plaine, MN (US)

(21) Appl. No.: 18/920,947

(22) Filed: Oct. 20, 2024

Related U.S. Application Data
(60) Provisional application No. 63/667,773, filed on Jul. 4, 2024.

(51) Int. Cl. G06N 3/08; G06N 3/0442

(52) U.S. Cl. CPC G06N 3/08; G06N 3/0442

(57) ABSTRACT

The envisioned Artificial Intelligence Long-term Memory System presents a significant advancement in artificial intelligence (AI) by addressing the challenge of transient memory in AI language models. This innovation introduces a hardware-centric approach to augment the memory faculties of AI language models, enabling them to store, access, refine, and incorporate specific data points for deeper user engagement. The enhancements focus on long-term memory, facilitating AI models to remember and build upon past interactions, thus offering a more natural and intuitive interaction between computers and users. The potential applications span from personal computing to complex medical diagnostics, marking a pivotal step towards AI models functioning with contextual awareness and memory retention akin to human interaction.

### RELATED U.S. APPLICATION DATA

Provisional application No. 63/667,773, filed on Jul. 4, 2024.

### BACKGROUND

The field of artificial intelligence (AI) has seen remarkable advancements in recent years, particularly in the areas of AI language models, natural language processing (NLP), and large language models (LLMs). These technologies have revolutionized the way machines understand and generate human language, enabling a wide range of applications from conversational agents to automated content creation.

AI language models are trained on vast datasets to predict the next word in a sequence, allowing them to generate coherent and contextually relevant text. However, without the long-term memory to store, access, refine and incorporate new data points, these models suffer from what would be akin to a form of amnesia in humans. Due to this lack of long-term memory, their ability to recall new facts or memories long-term is severely impaired.

Natural language processing (NLP) is the underlying technology that enables AI language models to interpret, understand, and generate human language. NLP combines computational linguistics with machine learning to process and analyze large amounts of natural language data. Large language models (LLMs) are a subset of AI language models that have been trained on even larger datasets. They are capable of understanding context and generating text that is often indistinguishable from that written by humans. Despite their capabilities, LLMs are constrained by the same memory limitations as other AI language models.

The Artificial Intelligence Long-term Memory System aims to solve the long-term memory problem found in AI language models. By creating a new Computer Processing Unit (CPU), Graphical Processing Unit (GPU), Neural Processing Units (NPU) or enhancing existing CPU/GPU/NPUs and compute processes, the memory enhancements add new long-term memory capabilities that allow for the storage, retrieval, refinement of responses, and inclusion of specific data points. This enables AI language models to compound multiple lines of thought together, allowing for deeper and more meaningful responses.

The key features prioritize memory enhancements that enable higher-level contextual programming, external interaction history such as dictation data between other AI models and/or users, data point storage, and internal response refinement. These enhancements are designed to provide a more human-like interaction experience for users.

These memory enhancements significantly improve the functionality and usefulness of AI language models by providing them with the ability to remember and build upon past interactions, leading to more natural and intuitive human and computer interactions.

### SUMMARY

The following encompasses a variety of potential embodiments that are designed to address the transient memory limitations present in current AI language models. These embodiments are crafted to enhance the long-term memory retention and recall capabilities of AI systems, thereby improving their overall functionality and performance.

One embodiment could be the creation of a new AI CPU/GPU/NPU chip that includes dedicated memory buffers for instructions, conversation history, data points, and internal response refinement. This chip would be at the core of the AI system, providing the necessary hardware support for enhanced long-term memory capabilities, shown in FIG. 4A.

Other embodiments might also offer variations in the number and configuration of memory buffers. These variations would cater to different AI applications, allowing for customization of memory resources based on the specific needs of the AI language model, as shown in FIG. 4B, FIG. 4C, FIG. 4D.

Another possible embodiment includes a cloud-based memory service that AI language models can utilize to offload and retrieve long-term data, as shown in FIG. 5. This would leverage the scalability of cloud computing to provide a flexible and expansive memory solution, ensuring that AI models can maintain a vast repository of information without being constrained by local hardware limitations.

Another embodiment may involve a modular memory expansion unit that can be retrofitted to existing AI language models. This unit would provide additional memory resources, enabling the AI to store and access information over extended periods. The modular nature of this unit allows for easy installation and scalability, depending on the memory demands of the AI system.

A distributed memory network embodiment would allow multiple AI language models to contribute to and draw from a shared memory pool. This collective approach to memory storage and retrieval would enhance the overall knowledge base and response accuracy of the participating AI models, fostering a collaborative learning environment.

The purposed memory enhancement solution could also encompass advanced memory optimization algorithms designed to enable AI language models to prioritize and retain the most relevant information. These algorithms would analyze the importance and relevance of data, ensuring that critical information is preserved while less pertinent data is discarded, thus optimizing memory usage. A natural point in time for this to occur is after said data has been rendered obsolete by virtue of it being compounded and refined upon by memory enhancement 4 104 as shown in FIG. 1.

Perhaps one or more of these potential embodiments is incorporated into new state-of-the-art computers and laptops that include the use of AI models allowing users to interact with these computers in much deeper and more meaningful ways.

These potential embodiments represent a significant advancement in the field of AI, providing language models with the necessary tools to overcome the challenges of transient memory and enabling them to engage in more complex and meaningful interactions.

### BRIEF DESCRIPTION OF DRAWINGS

FIG. 1 The illustration depicts a dataflow of interactions between the users, other AI models, the key components and features of the AI memory enhancements, and the AI language models, NLP models or LLMs.

FIG. 2 The illustration depicts an example set of instructions that would be accessed via the long-term storage provided by memory enhancement 1, memory storage for instructions 100 as shown in FIG. 1.

FIG. 3 The illustration depicts an example dataflow of a possible user prompt and response scenario highlighting the use of the instruction set provided by memory enhancement 1 to provide additional contextual refinement of the response by incorporating data from memory enhancements 2, 3 & 4, as shown in FIG. 1.

FIGS. 4A, 4B, 4C and 4D The illustrations represent various embodiments of an innovative CPU/GPU/NPU chip designed for the processing of response algorithms utilized in AI language models according to various examples described herein.

FIG. 4A The illustration represents an embodiment of an innovative CPU/GPU/NPU chip designed for the processing of response algorithms utilized in AI language models, incorporating four memory buffers that are allocated to store the data corresponding to each of the principal features.

FIG. 4B The illustration represents a variation on the embodiment depicted in FIG. 4A yet retaining the key features provided by the memory enhancements. This illustrates that the point is not in the specific number of buffers but in the overall long-term memory system that is created via the memory enhancements.

FIG. 4C The illustration represents another variation of the embodiment depicted in FIG. 4A but utilizing three of the four memory enhancements. In this variation the memory for internal interactions provided by enhancement 4 has not been included for a variety of reasons based on application and use cases.

FIG. 4D The illustration represents another variation of the embodiment depicted in FIG. 4A but utilizing three of the four memory enhancements. In this variation the memory for data points provided by enhancement 3 has not been included to illustrate another potential embodiment.

FIG. 5 The illustration represents an embodiment of a cloud-based memory service that AI language models can utilize to store and retrieve data to achieve the same long-term memory system.

FIG. 6A The illustration shows a human user speaking into a device with a microphone. That input data is then sent to speech-to-text AI model where that text is then sent to an AI language model using memory enhancements shown in FIG. 4A. The resulting text response is then sent as input to a text-to-speech AI model where it is then converted back into audio and transmitted via the speakers on the user's device.

FIG. 6B The illustration shows a human user speaking into a device with a microphone. That input data is then sent to a speech-to-text AI model where that text is then sent to an AI language model leveraging memory enhancements shown in FIG. 4A. The resulting response is then sent as input to a text-to-image AI model where it is then converted back into an image(s) and displayed on the screen on the user's device.

FIG. 6C The illustration shows a human user interacting with a device with a camera. That input data is then sent to a vision AI model where the resulting text output is then sent to an AI language model running on a new memory enhanced CPU/GPU/NPU chip shown in FIG. 4A. The resulting text response is then sent as input to a text-to-speech AI model where it is then converted back into audio and transmitted via the speakers on the user's device.

FIG. 6D The illustration shows a human user interacting with a device with a camera. That input data is then sent to a vision AI model where the resulting text is then sent to an AI language model running on a new memory enhanced CPU/GPU/NPU chip shown in FIG. 4A. The resulting text response is then sent as input to a text-to-image AI model where it is then converted back into an image(s) and displayed on the screen on the user's device.

FIG. 6E The illustration shows a human user speaking into a device with a microphone. That input data is then sent to speech-to-text AI model where that text is then sent to an AI language model running on a new memory enhanced CPU/GPU/NPU chip shown in FIG. 4A. The resulting text response is then displayed back to the user via the device display screen.

### DETAILED DESCRIPTION

The challenge addressed by the proposed Artificial Intelligence Long-term Memory System is delineated as follows: Contemporary artificial intelligence language models are hindered by a transient memory capacity, analogous to the long-term memory in humans, which is essential for retaining critical contextual information and data points. This limitation is akin to the memory impairment experienced by individuals with a form of amnesia, where recollection of facts is confined to the period preceding the memory loss event. In the context of AI language models, this event is represented by the last training date. Consequently, these models are incapable of assimilating new interactions, barring instances of re-training or updates by the developing entities.

With a limited short-term memory, these models invariably “forget” once this threshold is surpassed, precipitating a repetitive cycle. For users engaging with AI language models this may manifest as suboptimal responses, error messages, hallucination responses, or challenges in formulating queries to elicit the desired information. This impediment ostensibly diminishes the utility of current AI language models, as it restricts users from delving into the extensive expanse of human knowledge beyond superficial inquiries.

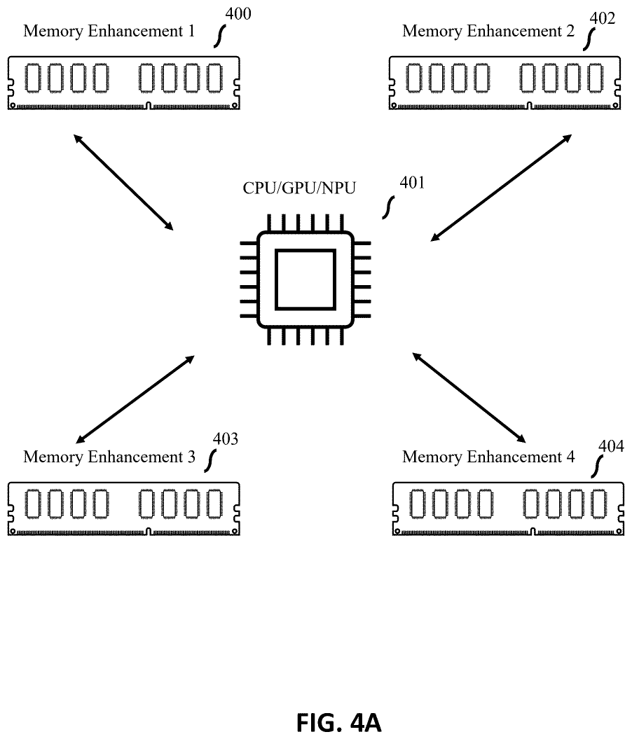

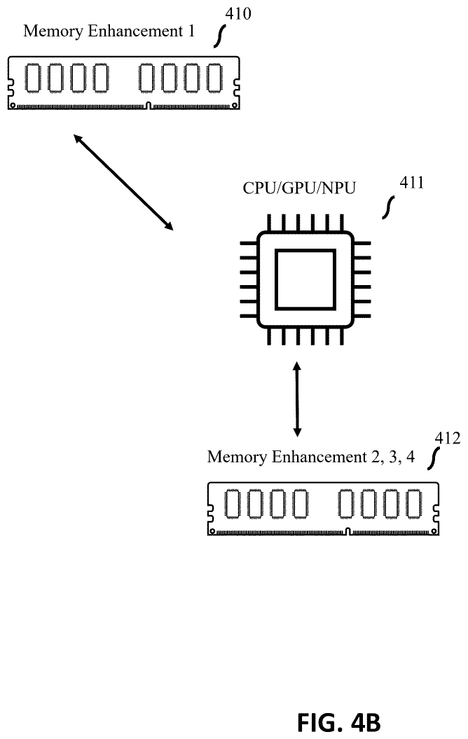

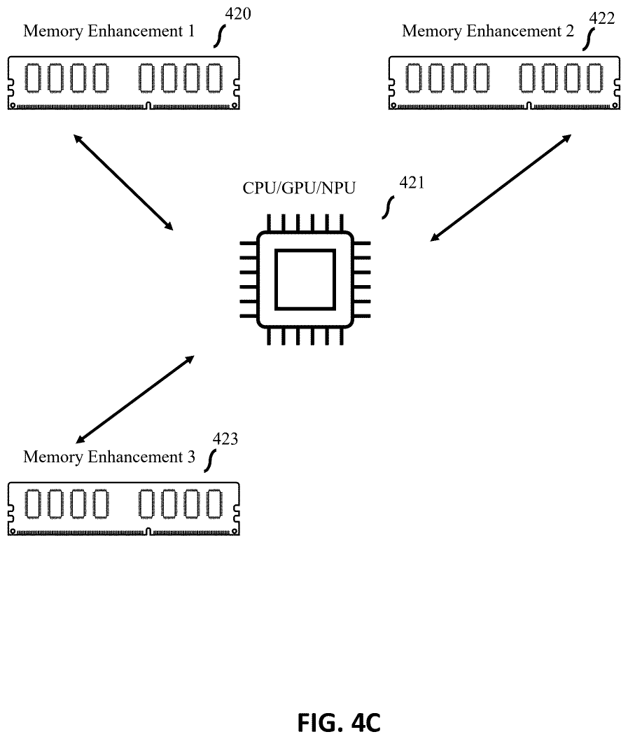

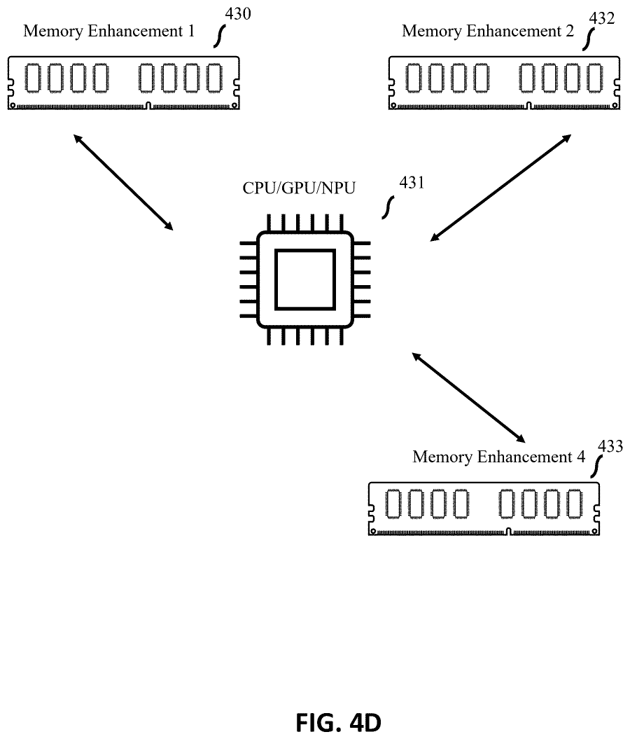

The principal elements and functionalities of the envisioned memory enhancements are designed to rectify the long-term memory constraints observed in extant AI language models. This objective will be achieved through the development of a novel central processing unit (CPU), graphical processing unit (GPU), or neural processing unit (NPU) specifically tailored for the operation of AI language model algorithms, as shown in FIG. 4A, or by augmenting existing CPU/GPU/NPUs and computational processes with enhanced long-term memory capabilities. The proposed enhancements to long-term memory and their respective purposes are outlined as follows:

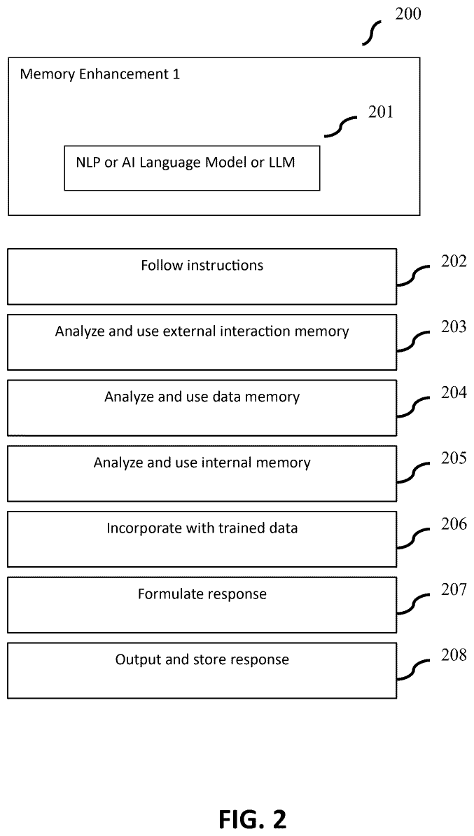

The first memory enhancement is to furnish the AI language models with a repository of directives, thereby facilitating advanced contextual programming. This provision will enable the incorporation of supplementary contextual data while crafting responses. It is imperative to clarify that AI language models possess no intrinsic comprehension of words and labels; rather, the directives serve solely to provide for enhanced contextual programming thus allowing for the usage of the other memory enhancements, as shown in FIG. 2.

The second memory enhancement is the establishment of a memory reserve for cataloging conversational history. This encompasses the interactive discourse between the user and the AI language model and extends to the data exchange between an AI language model and ancillary AI models, including but not limited to automated speech recognition, text-to-speech, text-to-image, and vision models.

The third memory enhancement is the creation of a memory module for the retention of data points. These may include, but are not limited to, personal identifiers such as a user's name, physical attributes like height and weight, or transactional details such as sales figures, customers and dates. This module is capable of storing a variety of data, encompassing numerical values, temporal markers, and categorical labels, and is also equipped to house unstructured data, for instance, a visual representation of a user's facial features.

The fourth memory enhancement is the provision of a memory mechanism dedicated to the internal refinement of responses. This entails an iterative internal dialogue aimed at enhancing the articulation of the AI language models. For example, this may involve the elimination of superfluous verbal fillers or minor adjustments in phrasing. Additionally, it encompasses the synthesis of numerous memories into a singular, more intricate memory response. Such a process is often overlooked by humans, yet it is a routine cognitive function, akin to the experience of deeming a thought as cogent until verbalized, followed by a subtle rewording for subsequent articulation. This feature is pivotal in empowering the AI language models to amalgamate a multitude of previous responses to inquiries, thereby formulating an entirely novel and original reply. This also takes into account those antecedent responses and integrates new information. Consequently, this enables the construction of profoundly deep and complex responses to intricate inquiries, which would otherwise be unattainable.

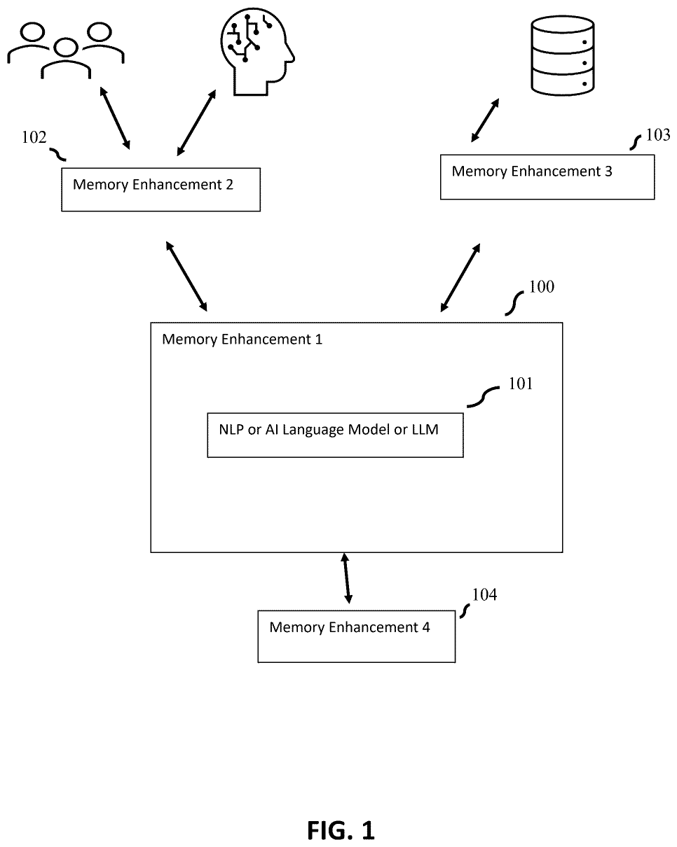

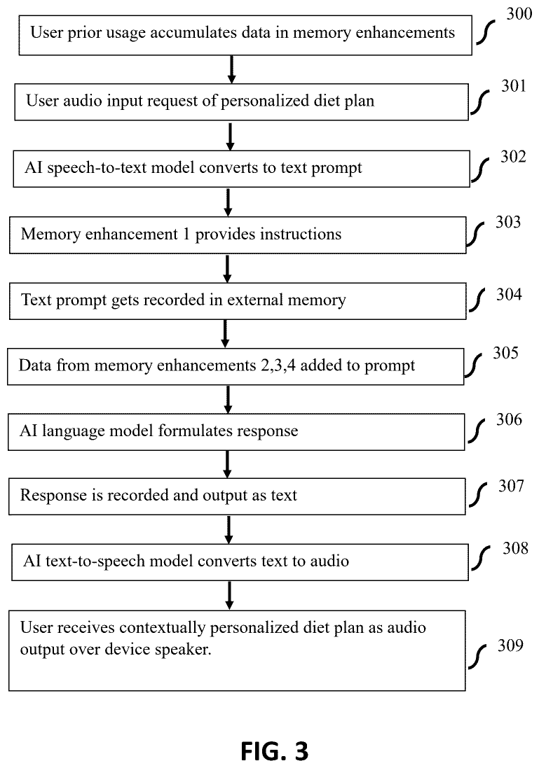

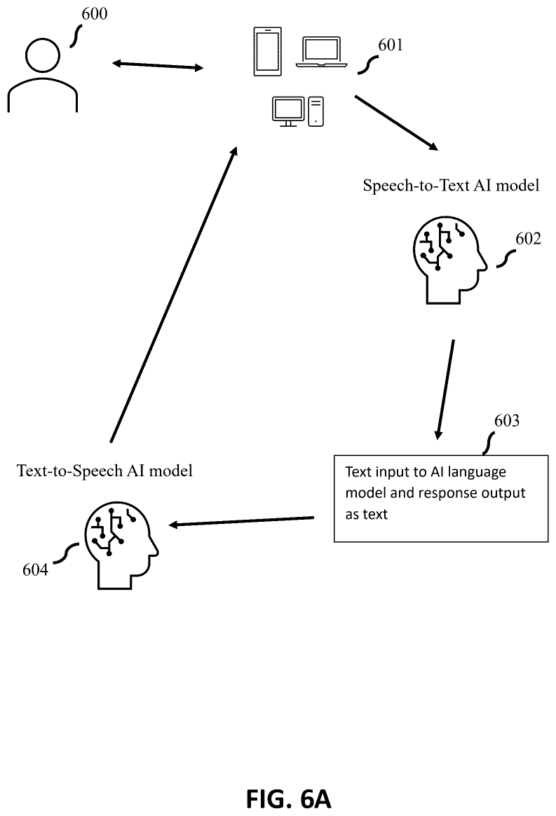

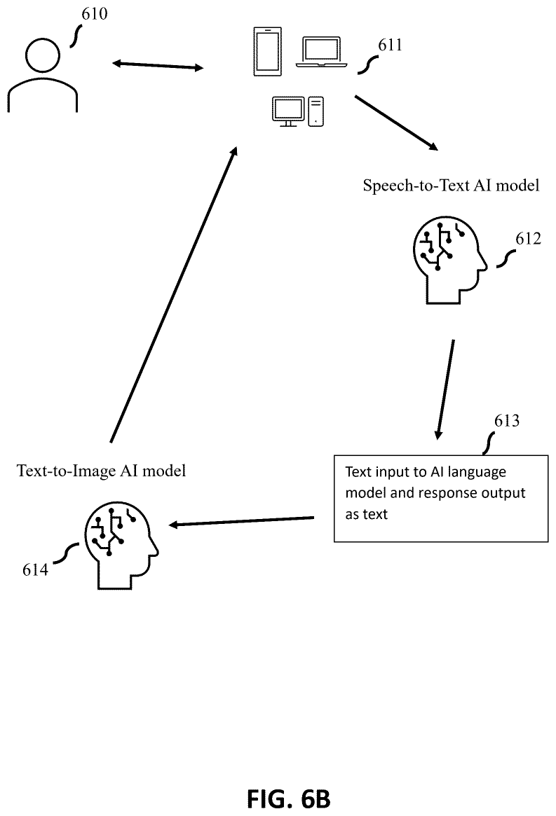

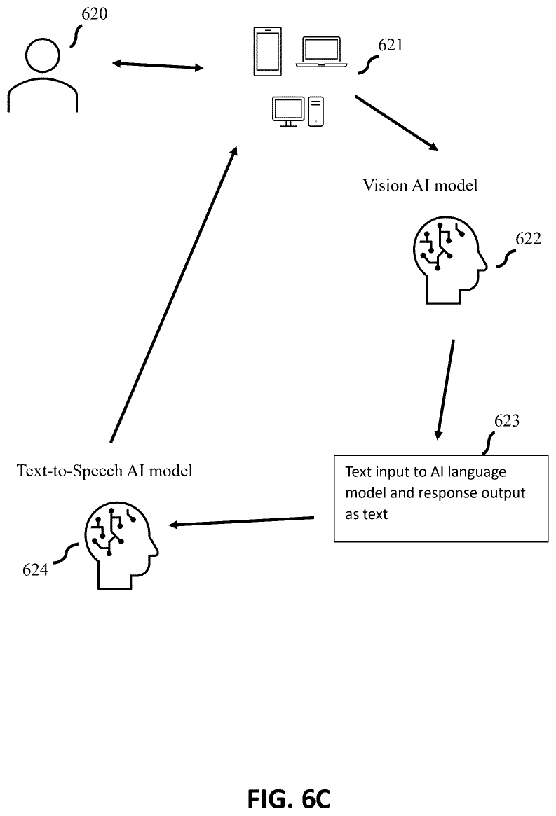

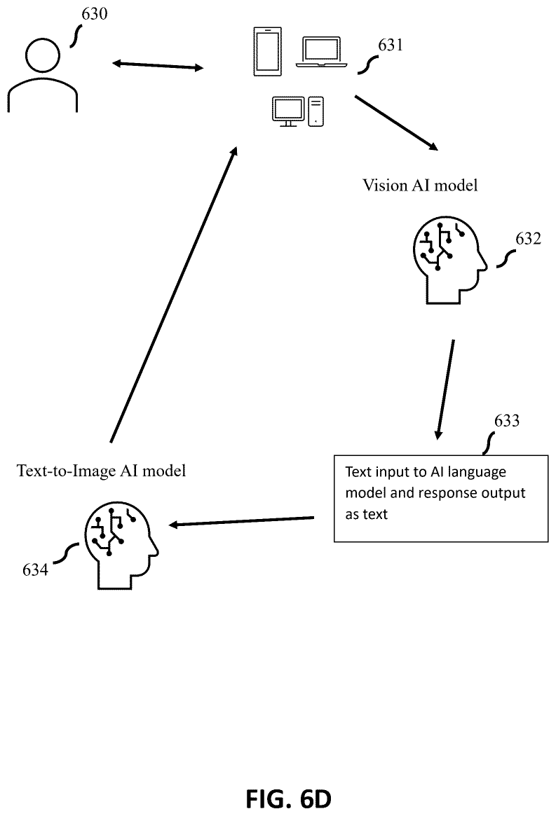

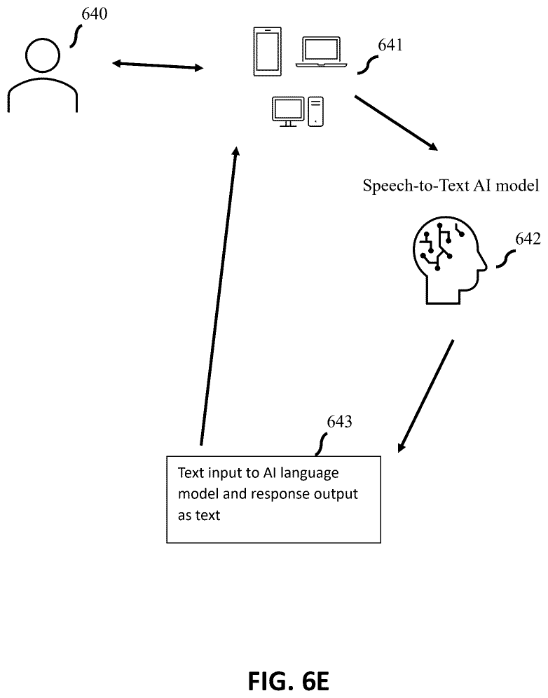

By endowing current AI language models with a long-term memory capability for the storage, retrieval, and refinement of initial responses, it unlocks their potential to amalgamate multiple threads of thought, yielding deeper and more meaningful interactions. This also obviates the need for users to consolidate several queries into a single prompt. Moreover, this long-term memory facilitates a virtually seamless interchange with other models, including but not limited to automated speech recognition, text-to-speech, text-to-image, and vision AI models, among others. For instance, the integration of memory as delineated above permits the AI language model to emulate human cognitive processes, with a microphone and ASR model functioning analogously to an ear, and a TTS model with a speaker serving as a mouth. With these components in place, a user can effortlessly converse with the computer, which will listen, formulate a response, and then vocalize it back to the user, shown in FIG. 1, FIG. 3, FIG. 6A.

The distinction of the purposed AI memory enhancements from other AI enhancements in the field is multifaceted. While some industry efforts focus on augmenting the processing speed of CPU/GPU/NPUs or expanding short-term memory to accommodate larger prompts, the approach purposed herein diverges significantly. Unlike any known endeavors, these memory enhancements seek to construct long-term memory storage akin to treating an amnesiac patient, thereby enabling AI language models to develop a “brain” with memory capabilities they inherently lack. The crux of these AI memory enhancements lies in the addition of memory to store instructions, which facilitates higher-level contextual programming of AI language models. This foundational feature underpins the utilization of the other memory enhancements detailed herein. By integrating these components and functions directly into the CPU/GPU/NPU and computational processes, the user remains unaware of the intricate memory exchanges occurring between AI models or within the AI language model for response refinement. The end result is a user experience that more closely resembles the futuristic computer interactions depicted in science fiction, moving beyond the antiquated QWERTY keyboard inputs from yesteryear FIG. 6A, FIG. 6B, FIG. 6C, FIG. 6D, FIG. 6E.

FIG. 1 shows an example dataflow of interactions between the users, other AI models, the key components and features of the AI memory enhancements, and the AI language models, NLP models or LLMs. Memory enhancement 1 100 is an instruction set that provides for a higher-level contextual programming of the AI language models 101. This provides them with the ability to utilize the other memory enhancements, 102, 103, 104, when formulating a response to the user. It is important to understand that the AI models have no understanding of words or labels, the instruction set, in providing higher-level contextual programming, simply gives them the ability to include additional information they would otherwise not be able to access and incorporate into a response.

As depicted in FIG. 1, memory enhancement 2 102, is memory storage to be used for housing the external interaction data between the user and the AI language models 101 in addition to the external interaction data of responses sent to other AI models for output to and from the user. This external data can be considered as dictation data and is stored along with a label or tag as determined by the instruction set 100. By storing external data in this manner, it allows for the system to recall past external interactions for as long as desired. This far exceeds the lifetime of a single user session that is currently available by AI language models 101.

As depicted in FIG. 1, memory enhancement 3 103, is memory storage to be used for housing specific data points relevant to the individual user. This includes both structured and non-structured data. For example, a user's height and weight, a picture of the user's face, relevant facts and figures such as sales or financial data or any other data including numbers, dates, strings . . . etc. The main tenant of this memory is to provide a uniquely distinct user experience by allowing for the AI language models 101 to personalize their responses by incorporating this data during formulation of their responses. The specific data points are also given a tag or label when stored as determined by the instruction set 100.

As depicted in FIG. 1, memory enhancement 4 104, is memory storage to be used for internal response refinement. This data storage is where single responses are effectively re-run through the AI language models 101, to remove any superfluous words, or possible hallucinations which are currently known to occur from existing AI language models 101. In addition, this memory storage allows for multiple other interactions whether internal, external or specific data points housed in the other memory enhancements 102, 103, 104, to be compounded together into a unique and ever increasingly deeper lines of thought. Such responses from the AI language models 101 would otherwise not be possible due to the current inability to incorporate multiple lines of thought. In similar fashion to the enhancements for external interactions and data points, this internal interaction data would also be stored along with a label or tag as determined by the instruction set 100. In order to maintain efficiencies, it would be beneficial for the instruction set 100 to include a means to allow for the pruning of data from memory enhancements 2,3 and 4 that are no longer needed and have been made obsolete by virtue of being incorporated, refined and compounded upon during the internal response refinement process.

FIG. 2 200, 201 shows an example set of instructions that would be accessed by the AI language models 101 via the long-term storage provided by memory enhancement 1 100 as shown in FIG. 1. The set of instructions provides for a higher-level contextual programming of the AI language models thus granting them the ability to incorporate additional contextual information stored in the other memory enhancements 102, 103, 104.

An example set of such instructions shown in FIG. 2 may be as follows: Follow instructions 202, is read by the AI language model prior to it receiving the prompt from the user and allows for the higher-level contextual programming. Analyze and use external memory 203, is next read in the sequence of instructions. This allows for the AI model to retrieve data from the external memory storage that has relevant contextual tags and use said information while formulating its response as per the instruction set. Analyze and use data memory to retrieve data points 204 with contextually relevant tags is next read in the example set of instructions. These data points are then used to further enrich the contextual relevance of the resulting response provided by the AI language model. Analyze and use internal memory 205 is the next set of instructions in the example. Data with contextually relevant labels are accessed in this storage and incorporated with the other data from the instructions above. Information in this storage section has already been compounded upon and further enriched during prior user sessions.

With the ability to take into consideration the additional contextual data provided during the execution of prior instructions, an instruction is then given where the original user prompt is then used by the AI language model and incorporated with its trained data 206 and a response is formulated 207. The formulated response is then provided back from the AI language model as output 208. The response provided is unique in the sense that it would not have been formulated without the additional contextual data that was provided via the memory enhancements. The response back from the AI language model is recorded and stored for long-term access and future use.

FIG. 3 Depicts a dataflow of a possible user prompt and response scenario. In this example, the user has accumulated prior data that has been stored in the memory enhancements 300. This data may include but not limited to prior responses related to internal and external interactions, data points such as a user's sex, height, weight, medical history and personal preferences including food likes and dislikes. The user then makes an audio request for a personalized diet plan as shown by this example 301. An AI speech-to-text model converts the audio request to text 302. Memory enhancement 1 provides a set of instructions providing the contextual programming needed to enable the usage of other memory enhancements including instructions on transitioning to and from other AI models 303. The text form of the user's request is recorded in external memory as per the set of instructions 304. Based on the instructions the text request is incorporated with additional contextually relevant information using data from memory enhancements 2,3,4 305. This information is then given to the AI language models to formulate a response to the request that now has been further contextually enriched 306. The resultant response is then recorded in internal and external memory as per the instructions given and output as text 307. The instructions also include information to pass the resultant text response to an AI text-to-speech model that converts the text into audio 308. The user then receives the response to their request for a personalized diet plan that is output as audio over their device speaker 309.

Given the manner in which the user's request is enhanced with highly pertinent contextual information, the resulting response, while grounded on trained data, is unique and tailored to the user. This enhancement improves the human interaction experience by enabling the user to receive responses to their inquiries that are more personally meaningful. In addition, the ability to compound upon and refine past responses allows the user to engage in increasingly deeper and deeper levels of conversation and lines of thought. The current transient memory limitations of AI models limit this type of human interaction experience.

FIG. 4A Illustrates an embodiment of an innovative CPU/GPU/NPU chip designed for processing response algorithms utilized in AI language models. In this illustration, each memory buffer represents one memory enhancement (1, 2, 3, 4 respectively); memory for instructions to the AI language models 400, 401, memory for external interactions 402, memory for data points 403, and memory for internal interactions such as response refinement 404. By integrating these components and functions directly into the CPU/GPU/NPU and computational processes, the user remains unaware of the intricate memory exchanges occurring between AI models or within the AI language model for response refinement. Another benefit of this approach is that it provides for optimal performance of each memory enhancement as they are not contending for resources. It should also be understood that while this depiction is perhaps the simplest to understand due to one memory buffer corresponding to one memory enhancement, this does not preclude a variety of other variations and embodiments as described in more detail herein.

FIG. 4B Illustrates an alternative embodiment of a CPU/GPU/NPU chip designed for processing response algorithms utilized in AI language models. In this illustration, one memory buffer for a dedicated repository of directives to the AI language models 410, 411. The illustration depicts a second memory buffer used to house the other 3 memory enhancements: memory for external interactions, memory for data points, and memory for internal interactions 412. A possible benefit of reducing the number of memory buffers in this fashion is to reduce the overall cost of the CPU/GPU/NPU. The point of this illustration is to convey that changing the number of memory buffers added to the CPU/GPU/NPU to be more or less may help balance performance against cost requirements while still maintaining the key features and benefits of the memory enhancements.

FIG. 4C Illustrates another variation of an embodiment of a CPU/GPU/NPU chip designed for processing response algorithms utilized in AI language models. In this illustration, each memory buffer represents one memory enhancement (1, 2, 3 respectively); memory for instructions to the AI language models 420, 421, memory for external interactions 422, memory for data points 423. Due to application or use case requirements, the memory enhancement for internal interactions has not been included in this configuration. Thus, allowing for all of the other key features and benefits of the other memory enhancements to remain intact. This level of modularization allows for a variety of application customizations.

FIG. 4D Shows another example of the modular capabilities by depicting another potential embodiment. In this illustration, each memory buffer represents one memory enhancement (1, 2, 4 respectively); memory for instructions to the AI language models 430, 431, memory for external interactions 432, memory for internal interactions 433. Due to application or use case requirements, the memory enhancement for data points has not been included in this configuration. This further illustrates the ability for a variety of application customizations.

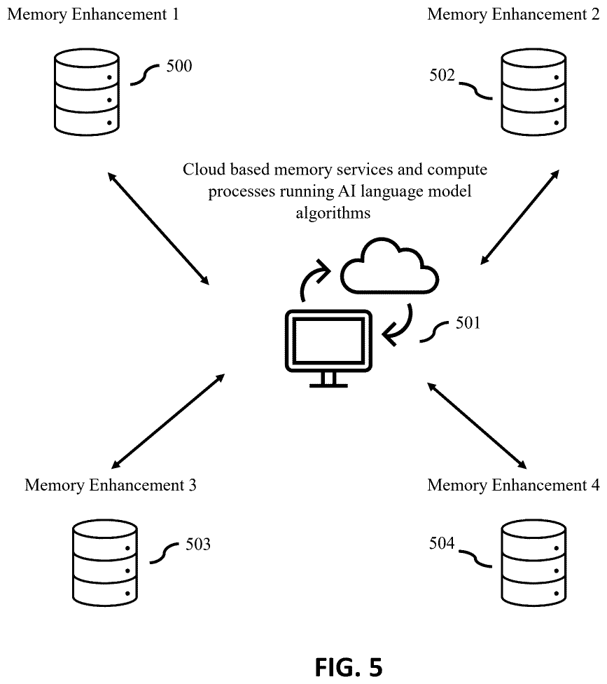

FIG. 5 Depicting an embodiment of a cloud-based memory service that AI language models 501 may possibly utilize to store and retrieve long-term data. Thus, achieving the same improved human interaction experience provided through the use of the memory enhancements 500, 502, 503, 504. This illustration is an acknowledgement of the ability of modern cloud computing to produce virtualized servers and computers. Once able to create a physical CPU/GPU/NPU with proposed memory enhancements then it would also be theoretically possible to virtualize this process in a cloud computing type of environment.

FIG. 6A Illustrates the nearly seamless integration between memory enhanced AI language model, LLMs, or other AI models involving natural language processing, and other ancillary AI models. The illustration depicts a human user speaking into a device with a microphone 600, 601. The input data is then transmitted to a speech-to-text AI model 602. The resulting text output from said ancillary AI model 602 is subsequently sent to an AI language model operating on a new memory-enhanced CPU/GPU/NPU chip 603 as shown in FIG. 4A. The resulting text response is then provided as input to a text-to-speech AI model 604, where it is converted back into audio and transmitted via the speakers on the user's device 601, ultimately being heard by the user 600.

FIG. 6B Illustrates a variation of the near seamless integration between memory enhanced AI language model, LLMs, or other AI models involving natural language processing, and other ancillary AI models. The illustration depicts a human user speaking into a device with a microphone 610, 611. The input data is then transmitted to a speech-to-text AI model 612. The resulting text output from said ancillary AI model 612 is subsequently sent to an AI language model operating on a new memory-enhanced CPU/GPU/NPU chip 613 as shown in FIG. 4A. The resulting text response is then provided as input to a text-to-image AI model 614, where it is converted back into an image response and displayed on the user's device 611, ultimately being seen by the user 610.

FIG. 6C Illustrates an additional variation of the integration between memory enhanced AI language model, LLMs, or other AI models involving natural language processing, and other ancillary AI models. The illustration depicts a human looking into a device with a camera 620, 621. The visual input data is then transmitted to a vision AI model 622. The resulting text output from said ancillary AI model 622 is subsequently sent to an AI language model operating on a new memory-enhanced CPU/GPU/NPU chip 623 as shown in FIG. 4A. The resulting text response is then provided as input to a text-to-speech AI model 624, where it is converted into audio and transmitted via the speakers on the user's device 621, where it is heard by the user 620.

FIG. 6D Illustrates yet another variation of the integration between memory enhanced AI language model, LLMs, or other AI models involving natural language processing, and other ancillary AI models. The illustration depicts a human user utilizing a device with a camera to capture an image 630, 631. The image input data is then transmitted to a Vision AI model 632. The resulting text output from said ancillary AI model 632 is then provided to an AI language model operating on a new memory-enhanced CPU/GPU/NPU chip 633 as shown in FIG. 4A. The resulting text response is then provided as input to a text-to-image AI model 634, where it is converted back into an image response and displayed on the user's device screen 631, this image is in turn then seen by the user 630.

FIG. 6E Is yet another variation of the integration between memory enhanced AI language model, LLMs, or other AI models involving natural language processing, and other ancillary AI models. The illustration depicts a human user speaking into a device with a microphone 640, 641. The input data is then transmitted to a speech-to-text AI model 642. The resulting text output from said ancillary AI model 642 is then sent to an AI language model operating on a new memory-enhanced CPU/GPU/NPU chip 643 as shown in FIG. 4A. The resulting text response is then displayed on the user's device screen 641, this is in turn read by the user 640. A possible use case may include, but not be limited to, a scenario where a user is wanting to write a paper with the assistance of AI and is enabled by the ability to simply speak the words they are wanting to write in the paper or ask the AI to help in phrasing of words and or sentences.

### CONCLUSION

The artificial intelligence memory enhancements and subsequent embodiments described herein provides for improved human interactions by creating a long-term memory system to allow said AI language models, LLMs and other analogous AI models using natural language processing techniques to store, access, refine and incorporate specific data points into their responses and creates a mechanism to compound multiple past responses into a single response. With the ability for memory enhanced AI language models to now possess long-term memory; the collection over time of the memory data described herein grants a contextual awareness on past interactions with the user(s). From the user(s) perspective this endows the memory enhanced AI language models to act more analogous to interacting with a human instead of a machine. This definitively passes the Turing Test, which is a test of a machine's ability to exhibit intelligent behavior equivalent to or indistinguishable from that of a human.

In addition, the transition to and from other ancillary AI models becomes greatly simplified as most all other ancillary models either accept text input or provide text output in turn, for example speech-to-text or text-to-speech models just to name a few. This is a profound aspect of the Artificial Intelligence Long-term Memory System since a user is no longer bound by their pre-existing ability to use a computer, such as having the ability to type on a keyboard. Instead, the user is now able to learn and explore avenues of information that may have otherwise been off limits. Not only does this increase the speed at which a user can interact with memory enhanced AI language models, but it also democratizes access to advanced AI technologies by helping to ensure that these technologies are inclusive and beneficial to a broader range of users. Furthermore, the embodiments described herein allow for a large variety of use case scenarios including personal computing and spans across many professions such as the science and medical fields.

What is claimed is:

1. An all-encompassing system architecture, which may include any combination of the following elements: a memory repository designed to house a comprehensive set of instructions, facilitating higher-level contextual programming of AI models including but not limited to AI language models, LLMs, and other similar models using natural language processing and this repository also enables the utilization of additional memory repositories, which can be leveraged by said AI models throughout their response generation processes; a memory repository established for the archival of external interaction data involving AI models including but not limited to AI language models, LLMs, and other similar models using natural language processing, and users, as well as intercommunications among various other AI models with this repository acting akin to a databank for the transcription of dialogues, encompassing user inquiries and AI language model responses which then further encompasses the facilitation of transitions to ancillary models, wherein the AI language model furnishes textual input to models, including, but not limited to, text-to-speech and text-to-image models and additionally, it incorporates the reception of textual output from AI models, notably those specializing in vision and speech recognition; a memory repository dedicated to the retention of specific data points, including, but not limited to, structured data such as numerical values, dates, and labels, as well as the storage of unstructured data, for instance, imagery; a memory repository established for the purpose of storing data, which shall be utilized by AI models including but not limited to AI language models, LLMs, and other similar models using natural language processing, to enhance the quality of their responses through an internal iterative improvement process with this storage facility permitting the amalgamation of multiple data points and previous responses, thereby enabling the formation of increasingly profound and meaningful responses and upon refinement, these responses shall be deemed unique to the extent that reproduction by the AI language models, without the aid of the memory enhancements described herein, would be exceedingly improbable.

2. A system as delineated in claim 1, comprising one or more memory repositories utilized for a set of instructions; these instructions facilitate a higher-level contextual programming of AI models, including but not limited to AI language models, large language models (LLMs), and other analogous models employing natural language processing which endows them with the capability to incorporate additional contextual information and data points within their responses.

3. A system as articulated in claim 1, comprising one or more memory repositories designated for external interactions with these interactions encompassing the systematic cataloging of conversational histories and data exchanges between AI models, including but not limited to AI language models, large language models (LLMs), and other comparable models utilizing natural language processing, as well as interactions with other AI models or users.

4. A system as propounded in claim 1, comprising one or more memory repositories for the retention of data points with the aforementioned memory being employed for the archiving of a diverse array of data, inclusive of both structured and unstructured forms with such data utilized by AI models, including but not limited to AI language models, large language models (LLMs), and other comparable models employing natural language processing, to further refine responses pertaining to or involving any aforementioned structured or unstructured data.

5. A system as expounded in claim 1, comprising one or more memory repositories for the purpose of internal response refinement with this provision serving as the working and long-term memory for a dedicated mechanism responsible for the internal refinement of responses, thereby facilitating the construction of intricate and sophisticated responses to complex inquiries and furthermore, it shall enable the integration of multiple responses and data points into increasingly complex responses provided by AI models, including but not limited to AI language models, large language models (LLMs), and other similar models employing natural language processing.

6. A system as delineated in claim 1, would confer upon AI models, including but not limited to AI language models, LLMs, and other analogous models utilizing natural language processing, the capability of advanced long-term memory with these models possessing the faculty to store, retrieve, refine, and integrate specific data points, thereby fostering a deeper and more meaningful engagement with users with this effectively addressing the issue of ephemeral memory, which hampers the models' capacity to maintain and employ new information over protracted durations.

7. The system delineated in claim 2 shall bestow upon AI models, including but not limited to AI language models, LLMs, and other analogous models employing natural language processing, an enhancement in contextual programming with the incorporation of memory for instructions permitting a higher echelon of contextual programming, enabling AI language models to integrate additional contextual data in the formulation of responses and this may also provide directives on the management of the nuances and priorities associated with some or all of the memory exchanges involved with the system.

8. The system delineated in claim 3 shall endow AI models, including but not limited to AI language models, LLMs, and other comparable models utilizing natural language processing, with the capability to recall and build upon previous interactions with this enhancement permitting users of the system to resume conversations and inquiries from past engagements, with the AI language models responding in a manner more akin to the contextual awareness characteristic of human-to-human interactions.

9. The system of claim 5 shall bestow upon AI models, including but not limited to AI language models, LLMs, and other comparable models utilizing natural language processing, the capability to amalgamate multiple lines of thought for the generation of increasingly complex responses to the user.

10. The system of claim 6 furnishes AI models, including but not limited to AI language models, LLMs, and other similar models employing natural language processing, with a form of contextual awareness coupled with memory retention capabilities.

11. The system of claim 3 shall facilitate a virtually seamless interchange with other AI models, including but not limited to automated speech recognition, text-to-speech, text-to-image, and vision models, thereby enhancing the interoperability and collaborative potential of the AI ecosystem.

12. The system of claim 5 shall employ memory optimization algorithms designed to enable AI language models to prioritize and retain the most pertinent information, thereby optimizing memory utilization.
